(19) United States
(12) Patent Application Publication
(10) Pub. No.: US 2004/0063879 A1
(43) Pub. Date: Apr. 1, 2004

(54) Process for making high molecular weight isobutylene polymers

(76) Inventors: Michael C. Baird, Kingston (CA); Mark J. Drewitt, Sarnia (CA); Kumar K. Rajesh, Vancouver (CA)

Correspondence Address: BAYER POLYMERS LLC, 100 BAYER ROAD, PITTSBURGH, PA, 15205, US

(21) Appl. No.: 10/466,859

(22) PCT Filed: Jan. 24, 2002
(86) PCT No.: PCT/CA02/00084

(30) Foreign Application Priority Data
Jan. 24, 2001 (CA) 2,332,203

(51) Int. Cl. C08F 4/52; C08F 4/58; C08F 4/46

(52) U.S. Cl. 526/177; 526/178; 526/179

(57) ABSTRACT

There is disclosed a process for polymerizing a cationically polymerizable olefin comprising the step of polymerizing at least one cationically polymerizable olefin at a subatmospheric pressure in the presence of a cationic polymerization catalyst system which comprises an initiator and an activator, which together form a reactive cation and non-co-ordinating anion, the activator being prepared by the reaction of a metalloid compound of formula (R₁R₂R₃)M with a co-initiator, the co-initiator being selected from the group consisting of an alcohol, a thiol, a carboxylic acid, a thiocarboxylic acid and the like.

### TECHNICAL FIELD

The present invention relates to a cationic polymerisation process for the preparation of high molecular weight isobutylene-based polymers.

### BACKGROUND ART

Cationic polymerization of olefins is known in the art.

Conventionally, cationic polymerization is effected using a catalyst system comprising: (i) a Lewis acid, (ii) a tertiary alkyl initiator molecule containing a halogen, ester, ether, acid or alcohol group, and, optionally, (iii) an electron donor molecule such as ethyl acetate. Such catalysts systems have been used for the so-called “living” and “non-living” carbocationic polymerization of olefins.

Catalyst systems based on halogens and/or alkyl-containing Lewis acids, such as boron trichloride and titanium tetrachloride, use various combinations of the above components and typically have similar process characteristics. For the so-called “living” polymerization systems, it is conventional for Lewis acid concentrations to exceed the concentration of initiator sites by 16 to 40 times in order to achieve 100 percent conversion in 30 minutes (based upon a degree of polymerization equal to 890) at −75° to −80° C.

Examples of the so-called “living” polymerization systems are taught in U.S. Pat. No. 4,929,683 and U.S. Pat. No. 4,910,321, the contents of each of which are incorporated herein by reference. Specifically, these patents teach the use of Lewis acids in combination with organic acids, organic esters or organic ethers to form cationic polymerization initiators that also create a complex counter anion. Apparently, the complex counter anion does not assist in or cause proton elimination.

In the so-called “non-living” polymerization systems, high molecular weight polyisobutylenes are prepared practically only at low temperatures (−60 to −100° C.) and at catalyst concentrations exceeding one catalyst molecule per initiator molecule. In practice, many of these catalyst systems are applicable only in certain narrow temperature regions and concentration profiles.

In recent years, a new class of catalyst systems utilising compatible non-co-ordinating anions in combination with cyclopentadienyl transition metal compounds (also referred to in the art as “metallocenes”) has been developed. See, for example, any one of:

published European patent application 0,277,003A;

published European patent application 0,277,004;

U.S. Pat. No. 5,198,401; and

published International patent application WO92/00333.

The use of ionising compounds not containing an active proton is also known. See, for example, any one of:

published European patent application 0,426,637A; and

published European patent application 0,573,403A.

U.S. Pat. No. 5,448,001 discloses a carbocationic process for the polymerization of isobutylene which utilizes a catalyst system comprising, for example, a metallocene catalyst and a borane.

WO 00/04061 discloses a cationic polymerization process which is conducted at subatmospheric pressure in the presence of a catalyst system such as Cp*TiMe₃ (the “initiator”) and B(C₆F₅)₃ (the “activator”). Such a system generates a reactive cation and a “non-coordinating anion” (NCA). Using such a catalyst system a polymer having desirable molecular weight properties may be produced in higher yields and at higher temperatures than by conventional means, thus lowering capital and operating costs of the plant producing the polymer.

The wide range of NCAs disclosed in WO 00/04061 includes aluminum, boron, phosphorous and silicon compounds, including borates and bridged di-boron species.

The polymerization of isobutylene with small amounts of isoprene, to produce butyl rubber, presents unique challenges. Specifically, as is well known in the art, this polymerization reaction is highly exothermic and it is necessary to cool the reaction mixture to approximately −95° C. in large scale production facilities. This requirement has remained, notwithstanding advances in the art relating to the development of novel reactor designs and/or novel catalyst systems.

Further, it is the case that the copolymers so produced have markedly lower molecular weights than homopolymers prepared under similar conditions. This is because the presence of isoprene in the monomer feed results in chain termination by B—H elimination.

It would be desirable to be able to obtain high molecular weight isobutylene-based polymers, and in particular isobutylene-based copolymers, in high yield, at relatively high temperatures (as compared to the methods of the art) and under more environmentally-friendly conditions. This has not been demonstrated to date.

### SUMMARY OF THE INVENTION

Amongst the large number of NCAs disclosed in WO 00/04061 there is disclosed a class of NCAs having the following structure:

[M′—Z—M″]^{d-}

wherein M′ and M″ may be the same or different and each has the formula M(Q₁ . . . Qₙ), wherein M is a metal or metalloid; and Q₁ to Qₙ are, independently, bridged or unbridged hydride radicals, dialkylamido radicals, alkoxide and aryloxide radicals, hydrocarbyl and substituted-hydrocarbyl radicals, halocarbyl and substituted-halocarbyl radicals and hydrocarbyl- and halocarbyl-substituted organometalloid radicals, with the proviso that not more than one of Q₁ to Qₙ may be a halide radical; and

Z is a μ-bonded bridging species selected from the group comprising OR⁻, SR⁻, SeR⁻, NR₂⁻, PR₂⁻, AsR₂⁻, SbR₂⁻, F⁻, Cl⁻, Br⁻ and I⁻, wherein R is selected from the group consisting of hydrogen, C₁-C₄₀ alkyl, C₁-C₄₀ cycloalkyl, C₅-C₄₀ aryl, halogen-substituted derivatives thereof and heteroatom-substituted derivatives thereof, and is an integer greater than or equal to 1.

We have now found that careful selection of a subset of the large family of such bridged NCAs disclosed in WO 00/04061 allows the preparation of a catalyst system having unexpected advantages over the systems disclosed therein.

Specifically, bridged compounds wherein M is selected from the group consisting of B, Al, Ga and In, which may be prepared by the addition of pre-determined amounts of a third component, (a “co-initiator”) to the appropriate activator, which, in combination with the initiator gives a catalyst system which allows the leads to a new catalyst system which allows the preparation of isobutylene polymers having even higher molecular weights than those disclosed in WO 00/04061. Further, these polymers are produced in very high yields. Sutable co-initiators include alcohols, thiols, carboxylic acids, thiocarboxylic acids and the like.

Such a system not only produces a polymer having a high molecular weight and associated narrow molecular weight distribution, but also results in greater monomer conversion. The polymerization is carried out at subatmospheric pressure, and has the further advantage that it can be carried out at higher temperatures than previously thought possible.

Further, the reaction can be carried out in solvents which are more environmentally friendly than those of the art.

### DETAILED DESCRIPTION OF THE INVENTION

Thus, the present process is directed to the polymerization of isobutylene

As mentioned hereinabove, the present process is particularly advantageous in the preparation of butyl rubber polymers. The term “butyl rubber” as used throughout this specification is intended to denote polymers prepared by reacting a major portion, e.g., in the range of from 70 to 99.5 parts by weight, usually 85 to 99.5 parts by weight of an isomonoolefin, such as isobutylene, with a minor portion, e.g., in the range of from 30 to 0.5 parts by weight, usually 15 to 0.5 parts by weight, of a multiolefin, e.g., a conjugated diolefin, such as isoprene or butadiene, for each 100 weight parts of these monomers reacted. The isoolefin, in general, is a C₄ to C₈ compound, e.g., isobutylene, 2-methyl-1-butene, 3-methyl-1-butene, 2-methyl-2-butene and 4-methyl-1-pentene. The preferred monomer mixture for use in the production of butyl rubber comprises isobutylene and isoprene. Optionally, an additional olefinic termonomer such as styrene, α-methylstyrene, p-methylstyrene, chlorostyrene, pentadiene and the like may be incorporated in the butyl rubber polymer. See, for example, any one of:

U.S. Pat. No. 2,631,984;

U.S. Pat. No. 5,162,445; and

U.S. Pat. No. 5,886,106.

The present process comprises the use of a cationic polymerization system comprising an initiator and an activator which, in combination which is a reactive cation and an activator, which is a compatible non-coordinating anion. Non-limiting examples of initiators useful in the practice of this invention are disclosed in PCT application WO 00/04061-A1.

For clarity, the formulae presented below depict the catalyst components in the “ionic” state. Of course, those of skill in the art will readily realise that many of these components are not stable as depicted and are obtained from a neutral stable form. For example, the species:

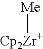

typically does not exist in this state alone. Rather, it is formed by reacting Cp₂ZrMe₂ with another compound that will abstract a Me group. This convention of describing the components in “ionic” form is used for descriptive purposes only and should not be construed as limiting in any way.

The following references teach the neutral stable forms, and the synthesis of the cyclopentadienyl transition metal compositions and the NCA:

International patent application WO 92/00333-A1;

European patent application 0,129,368A1;

European patent application 0,551,277

European patent application 0,520,732;

European patent application 0,277,003A1;

European patent application 0,277,004A1;

European patent application 0,426,637A;

European patent application 0,573,403A;

European patent application 0,520,732A;

European patent application 0,495,375A.

U.S. Pat. No. 5,017,714;

U.S. Pat. No. 5,055,438;

U.S. Pat. No. 5,153,157; and

U.S. Pat. No. 5,198,401.

For a description of compounds capable of producing the ionic species in situ see either of European patent applications 0,500,944A and 0,570,982A. These references teach in situ processes comprising the reaction of alkyl aluminum compounds with dihalosubstituted metallocene compounds prior to or with the addition of activating anionic compounds.

The neutral stable forms of the substituted carbocations and synthesis thereof are described in U.S. Pat. No. 4,910,321, U.S. Pat. No. 4,929,683 and European patent application 0,341,012. In general, the neutral stable form of such carbocations is typically represented by the formula:

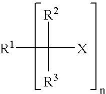

wherein R¹, R², and R³ are a variety of substituted or unsubstituted alkyl or aromatic groups or combinations thereof, n is the number of initiator molecules and is preferably greater than or equal to 1, even more preferably in the range of from 1 to 30, and X is the functional group on which the Lewis acid affects a change to bring about the carbocationic initiating site. This group is typically a halogen, ester, ether, alcohol or acid group depending on the Lewis acid employed.

For a discussion of stable forms of the substituted silylium and synthesis thereof, see F. A. Cotton, G. Wilkinson, Advanced Inorganic Chemistry, John Wiley and Sons, New York 1980. Likewise for stable forms of the cationic tin, germanium and lead compositions and synthesis thereof, see Dictionary of Organometallic compounds, Chapman and Hall New York 1984.

Initiators are selected from different classes of cations and cation sources. Some preferred classes are:

(A) cyclopentadienyl transition metal complexes and derivatives thereof;

(B) substituted carbocations;

(C) substituted silylium;

(D) compositions capable of generating a proton as further described below; and

(E) cationic compositions of germanium, tin or lead.

With reference to class (A), preferred cyclopentadienyl metal derivatives may be selected from the group consisting of compounds that are a mono-, bis- or tris-cyclopentadienyl derivative of a transition metal selected from Groups 4, 5 or 6 of the Periodic Table of Elements. Preferred compositions include mono-cyclopentadienyl (Mono-Cp) or bis-cyclopentadienyl (Bis-Cp) Group 4 transition metal compositions, particularly zirconium, titanium and/or hafnium compositions.

Preferred cyclopentadienyl derivatives are transition metal complexes selected from the group consisting of:

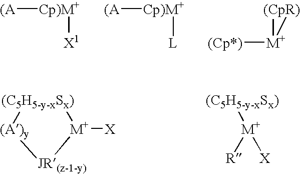

wherein:

(A—Cp) is either (Cp)(Cp*) or Cp—A′—Cp*;

Cp and Cp* are the same or different cyclopentadienyl rings substituted with from 0 to 5 substituent groups S, each substituent group S being, independently, a radical group selected from the group comprising hydrocarbyl, substituted-hydrocarbyl, halocarbyl, substituted-halocarbyl, hydrocarbyl-substituted organometalloid, halocarbyl-substituted organometalloid, disubstituted boron, disubstituted pnictogen, substituted chalcogen or halogen radicals, or Cp and Cp* are cyclopentadienyl rings in which any two adjacent S groups are joined forming a C₄ to C₂₀ ring system to give a saturated or unsaturated polycyclic cyclopentadienyl ligand;

R is a substituent on one of the cyclopentadienyl radicals which is also bonded to the metal atom;

A′ is a bridging group, which group may serve to restrict rotation of the Cp and Cp* rings or (C₅H_{5-y-x}Sₓ) and JR′(_{z-1-y}) groups;

M is a Group 4,5, or 6 transition metal;

y is 0 or 1;

(C₅H_{5-y-x}Sₓ) is a cyclopentadienyl ring substituted with from 0 to 5 S radicals;

x is from 0 to 5;

JR′(_{z-1-y}) is a heteroatom ligand in which J is a Group 15 element with a co-ordination number of three or a Group 16 element with a co-ordination number of 2, preferably nitrogen, phosphorus, oxygen or sulfur;

R″ is a hydrocarbyl group;

X and X¹ are independently a hydride radical, hydrocarbyl radical, substituted hydrocarbyl radical, halocarbyl radical, substituted halocarbyl radical, and hydrocarbyl- and halocarbyl-substituted organometalloid radical, substituted pnictogen radical, or substituted chalcogen radicals; and

L is an olefin, diolefin or aryne ligand, or a neutral Lewis base.

Other cyclopentadienyl compounds that may be used in the cationic polymerization catalyst system are described in:

European patent application 0,551,277A;

U.S. Pat. No. 5,055,438;

U.S. Pat. No. 5,278,119;

U.S. Pat. No. 5,198,401; and

U.S. Pat. No. 5,096,867.

With reference to class (B), a preferred group of reactive cations consists of carbocationic compounds having the formula:

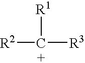

wherein R¹, R² and R³, are independently hydrogen, or a linear, branched or cyclic aromatic or aliphatic group, with the proviso that only one of R¹, R² and R³ may be hydrogen. Preferably, none of R¹, R² and R³ are H. Preferably, R¹, R² and R³, are independently a C₁ to C₂₀ aromatic or aliphatic group. Non-limiting examples of suitable aromatic groups may be selected from the group consisting of phenyl, tolyl, xylyl and biphenyl. Non-limiting examples of suitable aliphatic groups may be selected from the group consisting of methyl, ethyl, propyl, butyl, pentyl, hexyl, octyl, nonyl, decyl, dodecyl, 3-methylpentyl and 3,5,5-trimethylhexyl.

With reference to class (C), a preferred group of reactive cations consisting of substituted silylium cationic compounds having the formula:

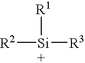

wherein R¹, R² and R³, are independently hydrogen, or a linear, branched or cyclic aromatic or aliphatic group, with the proviso that only one of R¹, R² and R³ may be hydrogen. Preferably, none of R¹, R² and R³ are H. Preferably, R¹, R² and R³ are, independently, a C₁ to C₂₀ aromatic or aliphatic group. More preferably, R¹, R² and R³ are independently a C₁ to C₈ alkyl group. Examples of useful aromatic groups may be selected from the group consisting of phenyl, tolyl, xylyl and biphenyl. Non-limiting examples of useful aliphatic groups may be selected from the group consisting of methyl, ethyl, propyl, butyl, pentyl, hexyl, octyl, nonyl, decyl, dodecyl, 3-methylpentyl and 3,5,5-trimethylhexyl. A particularly preferred group of reactive substituted silylium cations may be selected from the group consisting of trimethylsilylium, triethylsilylium and benzyldimethylsilylium. Such cations may be prepared by the exchange of the hydride group of the R₁R²R³Si—H with the NCA, such as Ph₃C⁺B(pfp)₄ yielding compositions such as R¹R²R³SiB(pfp)₄ which in the appropriate solvent obtain the cation.

With reference to class (D), the source for the cation may be any compound that will produce a proton when combined with the non-co-ordinating anion or a composition containing a non co-ordinating anion. Protons may be generated from the reaction of a stable carbocation salt which contains a non-co-ordinating, non-nucleophilic anion with water, alcohol or phenol to produce the proton and the corresponding by-product. Such reaction may be preferred in the event that the reaction of the carbocation salt is faster with the protonated additive as compared with its reaction with the olefin. Other proton generating reactants include thiols, carboxylic acids, and the like. Similar chemistries may be realised with silylium type catalysts. In another embodiment, when low molecular weight polymer product is desired an aliphatic or aromatic alcohol may be added to inhibit the polymerization.

Another method to generate a proton comprises combining a Group 1 or Group 2 metal cation, preferably lithium, with water, preferably in a wet, non-protic organic solvent, in the presence of a Lewis base that does not interfere with polymerization. A wet solvent is defined to be a hydrocarbon solvent partially or fully saturated with water. It has been observed that when a Lewis base, such as isobutylene, is present with the Group 1 or 2 metal cation and the water, a proton is generated. In a preferred embodiment the non-co-ordinating anion is also present in the “wet” solvent such that active catalyst is generated when the Group 1 or 2 metal cation is added.

With reference to class (E), another preferred source for the cation is substituted germanium, tin or lead cations. Preferred non-limiting examples of such cations include substances having the formula:

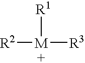

wherein R¹, R² and R³, are independently hydrogen, or a linear, branched or cyclic aromatic or aliphatic group, and M is germanium, tin or lead with the proviso that only one of R¹, R² and R³ may be hydrogen. Preferably, none of R¹, R² and R³ are H. Preferably, R¹, R² and R³are, independently, a C₁ to C₂₀ aromatic or aliphatic group. Non-limiting examples of useful aromatic groups may be selected from the group consisting of phenyl, tolyl, xylyl and biphenyl. Non-limiting examples of useful aliphatic groups may be selected from the group consisting of methyl, ethyl, propyl, butyl, pentyl, hexyl, octyl, nonyl, decyl, dodecyl, 3-methylpentyl and 3,5,5-trimethylhexyl.

The NCA component of the catalyst system is generated by reaction of an activator compound of formula:

(R₁R₂R₃)M

wherein:

M is B, Al, Ga or In;

R₁, R₂ and R₃ are independently selected bridged or unbridged halide radicals, dialkylamido radicals, alkoxide and aryloxide radicals, hydrocarbyl and substituted-hydrocarbyl radicals, halocarbyl and substituted-halocarbyl radicals and hydrocarbyl and halocarbyl-substituted organometalloid radicals, with the proviso that not more than one such R group may be a halide radical;

with a “co-initiator” which is an alcohol, a thiol, a carboxylic acid, a thiocarboxylic acid or the like. Preferred co-initiators are those having at least 8 carbon atoms, for example nonanol, octadecanol and octadecanoic acid. More preferred are those compounds which are at least partially fluorinated, for example hexafluoropropanol, hexafluoro-2-phenyl-2-propanol and heptadecafluorononanol.

In a preferred embodiment R₁ and R₂ are the same or different aromatic or substituted-aromatic hydrocarbon radicals containing from about 6 to about 20 carbon atoms and may be linked to each other through a stable bridging group; and R₃ is selected from the group consisting of hydride radicals, hydrocarbyl and substituted-hydrocarbyl radicals, halocarbyl and substituted-halocarbyl radicals, hydrocarbyl- and halocarbyl-substituted organometalloid radicals, disubstituted pnictogen radicals, substituted chalcogen radicals and halide radicals.

In a particularly preferred embodiment, M is B and R₁, R₂ and R₃ are each a (C₆F₅) group.

Without wishing to be bound by any particular theory, it is thought that the activator compound and the co-initiator together form a bridged species of formula:

[(R₁R₂R₃)M]₂—μZ]⁻

where Z represents the radical resulting from abstraction of the acidic proton from the co-initiator (for example, if the co-initiator is an alcohol (ROH) Z represents an alkoxy radical (OR)). At least 0.01 moles of co-initiator is employed per mole of activator, the maximum amount of co-initiator employed being 1 mole per mole of activator. More preferably, the ratio of co-initiator to boron compound is in the range of from 0.1:1 to 1:1, even more preferably in the range of from 0.25:1 to 1:1, and still more preferably in the range of from 0.5:1 to 1:1. Most preferably, 0.5 moles of co-initiator is employed per mole of activator, as this is the theoretical amount of co-initiator required to convert all of the activator originally present to the bridged di-boron species.

The present process is conducted at sub-atmospheric pressure. Preferably, the pressure at which the present process is conducted is less than 100 kPa, more preferably less than 90 kPa, even more preferably in the range of from 0.00001 to 50 kPa, even more preferably in the range of from 0.0001 to 40 kPa, even more preferably in the range of from 0.0001 to 30 kPa, most preferably in the range of from 0.0001 to 15 kPa.

The present process may be conducted at a temperature higher than −80° C., preferably at a temperature in the range of from −80° C. to 25° C., more preferably at a temperature in the range of from −40° C. to 25° C., even more preferably at a temperature in the range of from −30° C. to 25° C., even more preferably at a temperature in the range of from −20° C. to 25° C., most preferably at a temperature in the range of from 0° C. to 25° C.

The use of the co-initiators disclosed herein in a catalyst system for the preparation of isobutylene-based polymers has some unexpected advantages. The polymers so produced have high molecular weights, higher even than those disclosed in WO 00/04061-A1. This is even true in the case of isobutylene-based copolymers. Usually the introduction of a second monomer (such as isoprene (IP)) results in a copolymer having a molecular weight very much lower than that of a homopolymer produced under the same conditions, but this is not the case here—whilst the molecular weight of the isobutylene copolymer is still less than that of a homopolymer prepared under the same conditions, the drop in molecular weight is, surprisingly, significantly less than would be expected. Further, these polymerisation reactions are very fast and yields are very high, with monomer conversions of 100% being achieved in homopolymerisation reactions. Similar conversions were seen in copolymerisations in polar solvents. Yields in toluene were higher in the presence of co-initiators, especially in the presence of fluorinated alcohols.

Embodiments of the present invention will be described with reference to the following Examples which are provided for illustrative purposes only and should not be used to limit the scope of the invention.

### EXAMPLES

All glassware was dried by heating at 120° C. for at least 12 hours before being assembled. Nitrogen was purified by passing sequentially over heated BASF catalyst and molecular sieves. Dichloromethane was dried by refluxing over calcium hydride under nitrogen, toluene by refluxing over sodium-benzophenone under nitrogen, and both solvents were freshly distilled and then freeze-pump-thaw degassed prior to use. When necessary, solvents were stored over activated molecular sieves under nitrogen.

The diene monomer isoprene (IP) was purified by passing through a column to remove p-tertbutylcatechol, titrated with n-BuLi (1.6 M solution in hexanes) and distilled under vacuum prior to use. This was then stored at −30° C. in a nitrogen filled dry box.

Isobutylene (IB) was purified by passing through two molecular sieve columns and condensed into a graduated finger immersed in liquid nitrogen. The IB was allowed to melt, the volume noted (˜8 to 24 mL) and then refrozen by immersing in the liquid nitrogen bath. The system was evacuated to 10⁻³ torr, the IB finger isolated and the system placed under a nitrogen atmosphere.

Solutions of Cp*TiMe₃ (Cp*=η⁵-pentamethylcyclopentadienyl; Me=methyl; usually 11 mg, 0.05 mmol; recrystallized from pentane) and a mixture of B(C₆F₅)₃ (usually 25 mg, 0.05 mmol; sublimed), and octadecanol (usually 13 mg, 0.05 mmol, sublimed) both in 5 mL of solvent, were added and frozen in liquid nitrogen sequentially, giving an initiator to monomer ratio of approximately 1:1500. Both the solution of initiator and IB was brought to the desired temperature (using a cooling bath at about −30° C.) prior to the addition of the IB.

In some Examples an amount of diene equivalent to ˜1-3 mole % of the amount of IB was added to the IB finger prior to the condensation of the IB, this being done in a nitrogen-filled dry box.

Solutions of the olefin(s) and initiator system were generally stirred as long as possible under a static vacuum and at the predetermined temperature (by “static vacuum”, it is meant that the system was closed at this point and the pressure essentially was the vapour pressure of the remaining IB and solvent at the reaction temperature). When dichloromethane was use as the solvent copious amounts of polymeric materials generally began to precipitate after about 2 minutes. When toluene was the solvent a viscous solution was formed and stirring was maintained. Reactions were terminated after approximately 1 hour by precipitation into methanol (greater than 1 L). The precipitated material was dissolved in hexanes and the solvent flashed off under reduced pressure. The solid white polymer so obtained was dried to constant weight.

Table 1 shows the results of a series of isobutylene homopolymerisation reactions.

TABLE 1
homopolymerisation

| | | | | Activator: | Solvent | IB | Conversion | Mw | |
|---|---|---|---|---|---|---|---|---|---|
| Example | Initiator | Activator | Co-initiator | Co-initiator | (mL) | (mL) | (%) | (g/mol) | MWD |
| 1 | Cp*TiMe₃ | B(C₆F₅)₃ | — | | CH₂Cl₂ (15) | 9.5 | 100 | 504230 | 2.2 |
| 2 | Cp*ZrMe₃ | ″ | — | | CH₂Cl₂ (10) | 5.7 | 84 | 157300 | 2.2 |
| 3 | Cp*HfMe₃ | ″ | — | | CH₂Cl₂ (15) | 11.5 | 100 | 341550 | 4.7 |
| 4 | Cp*TiMe₃ | ″ | — | | Toluene (15) | 13 | 26 | 510600 | 1.7 |
| 5 | Cp*ZrMe₃ | ″ | — | | Toluene (15) | 9.5 | 7.2 | 431540 | 1.9 |
| 6 | Cp*HfMe₃ | ″ | — | | Toluene (15) | 12.5 | 12.5 | 227000 | 1.7 |
| 7 | Cp*TiMe₃ | ″ | Octadecanol | 1:1 | CH₂Cl₂ (15) | 21.1 | 100 | 708350 | 2.3 |
| 8 | Cp*TiMe₃ | ″ | Octadecanol | 1:1 | Toluene (15) | 9.8 | 25 | 1129000 | 1.9 |
| 9 | Cp*TiMe₃ | ″ | Heptadecafluoro- | 1:1 | CH₂Cl₂ (15) | 13 | 100 | 518710 | 1.8 |
| | | | nonanol | | | | | | |
| 10 | Cp*TiMe₃ | ″ | Heptadecafluoro- | 1:1 | Toluene (15) | 9.5 | 83 | 529320 | 2.0 |
| | | | nonanol | | | | | | |
| 11 | Cp*TiMe₃ | ″ | Octadecanoic | 2:1 | CH₂Cl₂ (15) | 9.7 | 85 | 858600 | 2.1 |
| | | | acid | | | | | | |
| 12 | Cp*TiMe₃ | ″ | Octadecanoic | 2:1 | Toluene (15) | 10.2 | 38 | 582710 | 1.4 |
| | | | acid | | | | | | |
| 13 | Cp*TiMe₃ | B(C₆F₅)₃ | Octadecane- | 1:1 | CH₂Cl₂ (15) | 12.0 | 100 | 864200 | 1.7 |
| | | | thiol | | | | | | |
| 14 | Cp*TiMe₃ | ″ | Octadecane- | 1:1 | Toluene (15) | 12.0 | 15 | 502950 | 1.6 |
| | | | thiol | | | | | | |
| 15 | Cp*TiMe₃ | ″ | Octadecane- | 2:1 | Toluene (15) | 12.0 | 34 | 1013050 | 1.6 |
| | | | thiol | | | | | | |
| 16 | Cp*TiMe₃ | ″ | Octadecane- | 1:1 | Toluene (15) | 12 | 21 | 472015 | 1.7 |
| | | | thiol | | | | | | |
| 17 | Cp*TiMe₃ | ″ | Octadecane- | 2:1 | Toluene (15) | 12 | 36 | 669700 | 1.8 |
| | | | thiol | | | | | | |
| 18 | Cp*TiMe₃ | ″ | Octadecane- | 1:1 | CH₃Cl (25) | 12 | 100 | 467530 | 2.4 |
| | | | thiol | | | | | | |
| 19 | Cp*TiMe₃ | ″ | Octadecane- | 2:1 | CH₃Cl (20) | 12 | 100 | 883900 | 1.8 |
| | | | thiol | | | | | | |
| 20 | Cp*HfMe₃ | ″ | Heptadecafluoro- | 1:1 | CH₂Cl₂ (15) | 12.5 | 100 | 353470 | 3.0 |
| | | | nonanol | | | | | | |
| 21 | Cp*HfMe₃ | ″ | Heptadecafluoro- | 1:1 | Toluene (15) | 13 | 92 | 233600 | 1.2 |
| | | | nonanol | | | | | | |

Table 2 shows the results of a series of isobutylene/isoprene copolymerisation reactions.

TABLE 1
copolymerisation

| | | | | Activator: | | IP | IB | Conversion | Mw | |
|---|---|---|---|---|---|---|---|---|---|---|
| Example | Initiator | Activator | Co-initiator | Co-initiator | Solvent | (mg) | (mL) | (%) | (g/mol) | MWD |
| 22 | Cp*TiMe₃ | B(C₆F₅)₃ | — | | CH₂Cl₂ (15) | 120 | 12.5 | 100 | 289500 | 1.8 |
| 23 | Cp*HfMe₃ | | — | | CH₂Cl₂ (15) | 130 | 13.0 | 100 | 157290 | 3.5 |
| 24 | Cp*TiMe₃ | | — | | Toluene (15) | 160 | 12.5 | 9 | 168700 | 1.5 |
| 25 | Cp*TiMe₃ | | Heptadecafluoro- | 1:1 | CH₂Cl₂ (15) | 115 | 12.5 | 100 | 735400 | 1.7 |
| | | | nonanol | | | | | | | |
| 26 | Cp*TiMe₃ | | Heptadecafluoro- | 1:1 | CH₂Cl₂ (15) | 200 | 13.0 | 93 | 370300 | 2.6 |
| | | | nonanol | | | | | | | |
| 27 | Cp*TiMe₃ | | Heptadecafluoro- | 1:1 | CH₂Cl₂ (15) | 300 | 13.0 | 82 | 300270 | 2.4 |
| | | | nonanol | | | | | | | |
| 28 | Cp*TiMe₃ | | Heptadecafluoro- | 1:1 | CH₂Cl₂ (15) | 115 | 13 | 100 | 583600 | 2.3 |
| | | | nonanol | | | | | | | |
| 29 | Cp*TiMe₃ | | Heptadecafluoro- | 1:1 | CH₂Cl₂ (15) | 235 | 13 | 80 | 396470 | 2.1 |
| | | | nonanol | | | | | | | |
| 30 | Cp*TiMe₃ | | Heptadecafluoro- | 1:1 | CH₂Cl₂ (15) | 300 | 13 | 92 | 405080 | 2.1 |
| | | | nonanol | | | | | | | |
| 31 | Cp*TiMe₃ | | Heptadecafluoro | 1:1 | Toluene (15) | 110 | 11.5 | 52 | 205288 | 1.5 |
| | | | nonanol | | | | | | | |
| 32 | Cp*TiMe₃ | | Heptadecafluoro- | 1:1 | Toluene (15) | 110 | 11.5 | 23 | 166400 | 1.6 |
| | | | nonanol | | | | | | | |
| 33 | Cp*TiMe₃ | B(C₆F₅)₃ | Octadecanol | 1:1 | Toluene (15) | 68 | 9.5 | 41 | 324380 | 1.9 |
| 34 | Cp*TiMe₃ | ″ | Octadecanoic | 2:1 | CH₂Cl₂ (15) | 120 | 6.9 | 100 | 494700 | 2.7 |
| | | | acid | | | | | | | |
| 35 | Cp*TiMe₃ | ″ | Octadecanoic | 1:1 | CH₂Cl₂ (15) | 115 | 13.0 | 40 | 342280 | 1.8 |
| | | | acid | | | | | | | |
| 36 | Cp*TiMe₃ | ″ | Octadecane- | 1:1 | CH₂Cl₂ (15) | 235 | 12.0 | 25 | 386550 | 1.9 |
| | | | thiol | | | | | | | |
| 37 | Cp*TiMe₃ | ″ | Octadecane- | 1:1 | CH₃Cl (40) | 240 | 12 | 97 | 615560 | 1.6 |
| | | | thiol | | | | | | | |
| 38 | Cp*TiMe₃ | ″ | Octadecane- | 1:1 | CH₃Cl (50) | 230 | 12 | 100 | 366560 | 2.4 |
| | | | thiol | | | | | | | |
| 39 | Cp*TiMe₃ | ″ | Octadecane- | 1:1 | CH₃Cl (50) | 230 | 12 | 100 | 443560 | 1.6 |
| | | | thiol | | | | | | | |
| 40 | Cp*HfMe₃ | ″ | Octadecanol | 1:1 | CH₂Cl₂ (15) | 130 | 13.0 | 27 | 311650 | 1.7 |
| 41 | Cp*HfMe₃ | ″ | Hexafluoro- | 1:1 | CH₂Cl₂ (15) | 110 | 13.0 | 100 | 232750 | 3.5 |
| | | | propan-2-ol | | | | | | | |
| 42 | Cp*HfMe₃ | ″ | Hexafluoro-2- | 1:1 | CH₂Cl₂ (15) | 120 | 13.0 | 81 | 376380 | 2.6 |
| | | | phenyl-propan- | | | | | | | |
| | | | 2-ol | | | | | | | |
| 43 | Cp*HfMe₃ | ″ | Octadecanoic | 1:1 | CH₂Cl₂ (15) | 115 | 13.0 | 93 | 423240 | 1.5 |
| | | | acid | | | | | | | |

The results support the conclusion that conducting the polymerization of isobutylene at sub-atmospheric pressure using the catalyst system disclosed herein results in the production of a polymer having a higher Mw when compared to carrying out the polymerization in the absence of co-initiator. Similarly, the results support the conclusion that conducting the co-polymerization of isobutylene/isoprene under similar conditions results in the production of a copolymer having a higher Mw when compared to conducting the polymerization or copolymerisation of isobutylene in the absence of the co-initiator.

The above embodiments of the disclosed invention detail experiments which were carried out at subatmospheric pressure. Without intending to be bound by any particular theory, it is thought that carrying out the reactions at subatmospheric pressure permits excellent heat transfer to take place within the reaction medium, thus preventing the occurrence and/or build-up of “hot-spots”, which are known to be detrimental. Thus, any means which would facilitate excellent heat transfer (for example, highly efficient cooling, improved reactor design) is encompassed by the invention disclosed herein.

With respect to U.S. patent practise and all other jurisdictions providing for this possibility, all publications, patents and patent applications referred to herein are incorporated by reference in their entirety to the same extent as if each individual publication, patent or patent application was specifically and individually indicated to be incorporated by reference in its entirety.

What is claimed is:

1. A process for polymerizing a cationically polymerizable olefin comprising the step of polymerizing at least one cationically polymerizable olefin at a subatmospheric pressure in the presence of a cationic polymerization catalyst system which comprises an initiator and an activator, which together form a reactive cation and non-co-ordinating anion, the activator being prepared by the reaction of a compound of formula:
(R₁R₂R₃)M
wherein:
M is B, Al, Ga or In;
R₁, R₂ and R₃ are independently selected bridged or unbridged halide radicals, dialkylamido radicals, alkoxide and aryloxide radicals, hydrocarbyl and substituted-hydrocarbyl radicals, halocarbyl and substituted-halocarbyl radicals and hydrocarbyl and halocarbyl-substituted organometalloid radicals, with the proviso that not more than one such R group may be a halide radical;
with a co-initiator, the co-initiator being selected from the group consisting of an alcohol, a thiol, a carboxylic acid, a thiocarboxylic acid and the like.

2. A process according to claim 1 wherein M is B.

3. A process according to claim 1 wherein the ratio of co-initiator to (R₁R₂R₃)M is in the range of from 0.01:1 to 1:1.

4. A process according to claim 3 wherein the ratio of co-initiator to (R₁R₂R₃)M is in the range of from about 0.1: 1 to about 1: 1.

5. A process according to claim 1 wherein the reactive cation is a cyclopentadienyl transition metal complex.

6. A process according to claim 5 wherein the transition metal complex is a compound selected from the group consisting of: 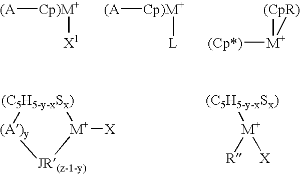
wherein:
(A—Cp) is either (Cp)(Cp*) or Cp—A′—Cp*;
Cp and Cp* are the same or different cyclopentadienyl rings substituted with from 0 to 5 substituent groups S, each substituent group S being, independently, a radical group selected from the group comprising hydrocarbyl, substituted-hydrocarbyl, halocarbyl, substituted-halocarbyl, hydrocarbyl-substituted organometalloid, 10 halocarbyl-substituted organometalloid, disubstituted boron, disubstituted pnictogen, substituted chalcogen or halogen radicals, or Cp and Cp* are cyclopentadienyl rings in which any two adjacent S groups are joined forming a C₄ to C₂₀ ring system to give a saturated or unsaturated polycyclic cyclopentadienyl ligand;
15 R is a substituent on one of the cyclopentadienyl radicals which is also bonded to the metal atom;
A′ is a bridging group, which group may serve to restrict rotation of the Cp and Cp* rings or (C₅H_{5-y-x}Sₓ) and JR′(_{z-1-y}) groups;
M is a Group 4,5, or 6 transition metal;
y is 0 or 1;
(C₅H_{5-y-x}Sₓ) is a cyclopentadienyl ring substituted with from 0 to 5 S radicals;
x is from 0 to 5;
JR′(_{z-1-y}) is a heteroatom ligand in which J is a Group 15 element with a co-ordination number of three or a Group 16 element with a co-ordination number of
2, preferably nitrogen, phosphorus, oxygen or sulfur;
R″ is a hydrocarbyl group;
X and X¹ are independently a hydride radical, hydrocarbyl radical, substituted hydrocarbyl radical, halocarbyl radical, substituted halocarbyl radical, and hydrocarbyl- and halocarbyl-substituted organometalloid radical, substituted pnictogen radical, or substituted chalcogen radicals; and
L is an olefin, diolefin or aryne ligand, or a neutral Lewis base.

9. A process according to claim 1 wherein R₁, R₂ and R₃ are independently selected aromatic or substituted aromatic hydrocarbon radicals having in the range of from 6 to 20 carbon atoms, and which may be linked to each other by a table bridging group.

10. A process according to claim 2 wherein R₁, R₂ and R₃ are each a C₆F₅ group.

11. A process according to claim 1 wherein the co-initiator is fluorinated.

12. A process according to claim 1 wherein the reaction is carried out at a temperature higher than −100° C.

13. A process according to claim 1 wherein the subatmospheric pressure is less than about 100 kPa.

14. A process according to claim 1 wherein the at least one cationically polymerizable olefin comprises a mixture of isobutylene and isoprene.

15. A process for polymerizing a cationically polymerizable olefin comprising the step of polymerizing at least one cationically polymerizable olefin in the presence of a cationic polymerization catalyst system which comprises an initiator and an activator, the activator being prepared by the reaction of a compound of formula
(R₁R₂R₃)M
wherein:
M is B, Al, Ga or In;
R₁, R₂ and R₃ are independently selected bridged or unbridged halide radicals, dialkylamido radicals, alkoxide and aryloxide radicals, hydrocarbyl and substituted-hydrocarbyl radicals, halocarbyl and substituted-halocarbyl radicals and hydrocarbyl and halocarbyl-substituted organometalloid radicals, with the proviso that not more than one such R group may be a halide radical;
with a co-initiator, the co-initiator being selected from the group consisting of an alcohol, a thiol, a carboxylic acid, a thiocarboxylic acid and the like, the reaction being carried out such that highly efficient cooling of the reaction mixture occurs.
